(19) United States
(12) Patent Application Publication
(10) Pub. No.: US 2014/0228073 A1
(43) Pub. Date: Aug. 14, 2014

(54) AUTOMATIC PRESENTATION OF AN IMAGE FROM A CAMERA RESPONSIVE TO DETECTION OF A PARTICULAR TYPE OF MOVEMENT OF A USER DEVICE

(71) Applicant: LSI CORPORATION, San Jose, CA (US)

(72) Inventors: Roger A. Fratti, Mohnton, PA (US); James R. McDaniel, Nazareth, PA (US)

(73) Assignee: LSI Corporation, San Jose, CA (US)

(21) Appl. No.: 13/767,302

(22) Filed: Feb. 14, 2013

(51) Int. Cl. H04W 4/02

(52) U.S. Cl. CPC H04W 4/027
USPC 455/556.1

(57) ABSTRACT

A user device comprises a housing, a processor, a position sensor coupled to the processor, a camera coupled to the processor and a display coupled to the processor. The position sensor is configured to detect at least one particular type of movement of the user device. The display is viewable through at least a portion of a front surface of the housing. The processor is configured to automatically present on the display at least a portion of an image from the camera responsive to the position sensor detecting a given movement of the particular type.

### FIELD

The field relates generally to user devices, and, more particularly, to displaying content on a user device.

### BACKGROUND

Cell phones, mobile computing devices and other user devices are widespread and ubiquitous in the world today. Use of such devices occurs at all times of the day and in various situations. Various issues have arisen as a result of users becoming distracted while using such devices. For example, there are now various laws and regulations which prohibit texting while driving, or otherwise limit the use of cell phones and other user devices during driving for safety reasons.

Issues can also arise with the use of cell phones and other devices while walking, jogging and performing various other activities. For example, there are various reported cases of users walking into objects, stumbling, falling off train platforms, etc. when using cell phones while moving. Currently, cell phones and other user devices fail to provide adequate capability for the safe use of such devices while the user is moving.

### SUMMARY

In one embodiment, a user device comprises a housing, a processor, a position sensor coupled to the processor, a camera coupled to the processor and a display coupled to the processor. The position sensor is configured to detect at least one particular type of movement of the user device. The display is viewable through at least a portion of a front surface of the housing. The processor is configured to automatically present on the display at least a portion of an image from the camera responsive to the position sensor detecting a given movement of the particular type.

Other embodiments of the invention include, by way of example and without limitation, integrated circuits, methods and computer-readable storage media having computer program code embodied therein.

### BRIEF DESCRIPTION OF THE DRAWINGS

FIG. 1 shows a user device, according to an embodiment of the invention.

FIG. 2 shows the user device of FIG. 1, according to an embodiment of the invention.

FIG. 3 shows a presentation of content on the user device of FIG. 1, according to an embodiment of the invention.

FIG. 4 shows another presentation of content on the user device of FIG. 1, according to an embodiment of the invention.

FIG. 5 shows a methodology for content presentation, according to an embodiment of the invention.

### DETAILED DESCRIPTION

Embodiments of the invention will be illustrated herein in conjunction with exemplary user devices, methods, etc. It is to be understood, however, that techniques of the present invention are not limited to the user devices and methods shown and described herein. For example, while various embodiments of the invention may be described with respect to a user device which is a cell phone, the invention is not limited solely for use in cell phones. Instead, the invention is more generally applicable to a wide variety of user devices, including but not limited to items such as tablets, personal digital assistants, handheld gaming devices, mobile user devices, mobile communication devices, etc. Likewise, embodiments of the invention may be used in conjunction with user devices of a variety of form factors, including but not limited to those commonly referred to within the field as tablets, smartphones, clamshells, sliders, etc. Further, although embodiments of the invention depict a user device with a touch screen input display, embodiments of the invention may use any input device or combination of input devices, such as trackballs, styluses, touchpads, microphones, keyboards, etc. Likewise, the display of the user device may be any one of or combination of display types such as liquid crystal display (LCD), light emitting diode (LED) display, plasma display, electronic paper, etc. Additional embodiments may be implemented using components other than those specifically shown and described in conjunction with the illustrative embodiments.

In many user devices such as cell phones, there is no capability or other function which permits the user to safely use the device while walking, jogging or otherwise moving. As such, embodiments of the invention provide techniques for detecting particular types of movement of a user device and displaying an image in a direction of movement of the user device.

FIG. 1 illustrates a user device 100. The user device 100 has a processor 104, operatively connected to a number of elements including a position sensor 102, a display 106, a camera 108 and a memory 110. The position sensor 102 may be one of or a combination of various sensor types. For example, the position sensor 102 may be a motion sensor, an accelerometer, a gyroscope, a global positioning system (GPS) sensor, etc. The processor 104 may comprise, for example, a microprocessor, an application-specific integrated circuit (ASIC), a field-programmable gate array (FPGA), a central processing unit (CPU), or other similar processing device components, as well as combinations of such components. Display 106 may be one of, or a combination of, various display types, such as LED, LCD, plasma, electronic paper, etc. as discussed above. The camera 108, may be one of, or a combination of, various camera types as known in the art. The memory 110 may comprise, for example, random access memory (RAM), read-only memory (ROM), magnetic memory, optical memory, hard disk drive (HDD) memory, flash memory, or other types of storage devices in any combination.

While not explicitly shown in FIG. 1, the user device 100 may also have a network interface component for communicating over a network such as a wide area network (WAN) such as the Internet, a local area network (LAN), a cellular network, a Bluetooth® network, a near field communication (NFC) network or any other type of network, as well as combinations of multiple networks. The user device 100 may also comprise a number of other components such as speakers, microphones, one or more input buttons or devices, etc., as will be appreciated by one skilled in the art.

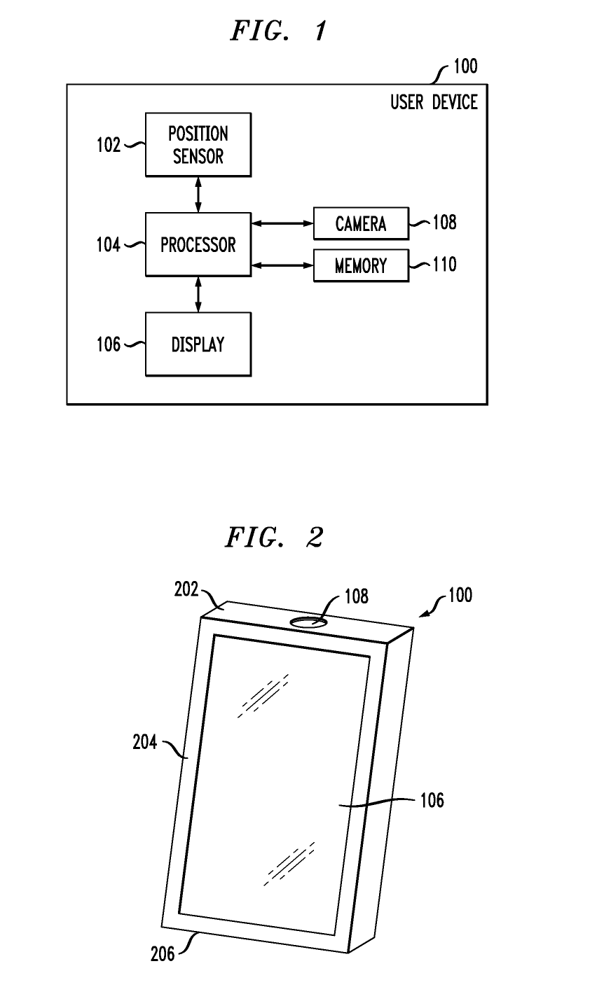

FIG. 2 shows a perspective view of the housing 206 of user device 100. The display 106 is positioned such that it is viewable from a front surface 204 of the housing 206 of the user device 100. The camera 108 is mounted on a top surface 202 of the housing 206. While FIG. 2 shows a user device with a camera mounted on the top surface 202 of the housing 206, in other embodiments of the invention one or more additional cameras may be mounted on other surfaces of the housing such as the back surface or a side surface of the housing 206.

FIG. 2 shows the camera 108 mounted so as to capture an image substantially perpendicular to a planar surface of the display 106. In some embodiments, however, the camera 108 may not be mounted on the top surface 202 of the housing 206. Many user devices such as cell phones come equipped with rear cameras used to take pictures and capture video. Embodiments of the invention may use existing cameras mounted on the back surfaces of a user device such as a cell phone.

In other embodiments, the camera 108 may be mounted at an angle so as to capture an image which is not substantially perpendicular to the planar surface of the display 106. For example, the camera 108 may be mounted at an angle approximately 30 to 60 degrees below a plane parallel to the top surface 202 of the housing 206 such that when the user device 100 is held by a user at an angle, the camera 108 substantially captures a view in front of the user. One skilled in the art will readily appreciate that a variety of other angles may be used. For example, different mounting angles may be used if the top surface 202 of the housing is curved or sloped with respect to a planar surface of the display 106 of the user device 100. As another example, different mounting angles may be used if the camera 108 is not mounted on the top surface 202 of the housing 206 but is instead mounted on another surface such as the rear surface of the housing of the user device 100.

The user device 100 may be configured so as to automatically detect a particular type of movement and automatically present or output an image of the direction of movement on the display 106. It is important to note that the term “output” as used herein is intended to be construed broadly. For example, in some display technologies such as LCD displays, the content on the screen of the display is continually output or refreshed periodically. In other display technologies, the content of the screen is output once and not refreshed or changed until some action by the user. Accordingly, output is to be construed broadly to cover a wide variety of display technologies. In addition, the term “present” as used herein is intended to be construed broadly as outputting the image or other content viewable by a user on the screen of the display.

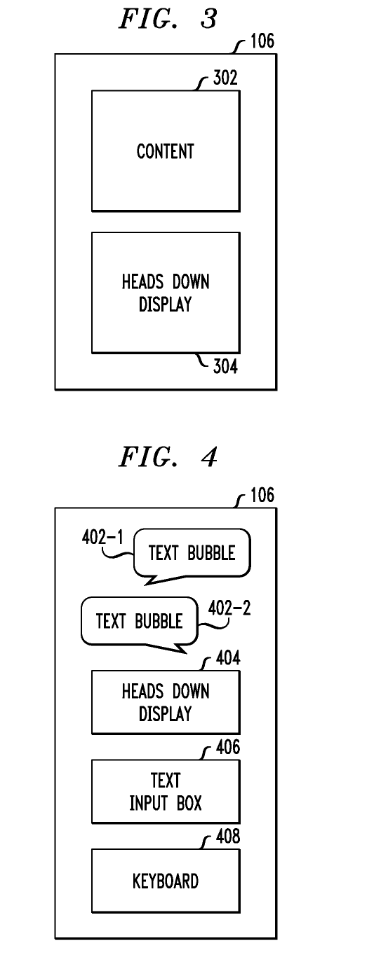

FIG. 3 shows an example of the presentation on the display 106 on detection of a particular type of movement. A portion of the display 106 shows content 302 and a portion of the display shows heads down display content 304. The content 302 is the normal image or some portion thereof which would otherwise be displayed on the user device 100. The heads down display content 304 is at least a portion of an image captured from the camera 108. The heads down display content 304 may show a video captured from the camera 108 as the user device 100 moves. The heads down display content 304 may alternately display a static image from the camera 108. The static image may be updated periodically, such as every x seconds.

It is important to note that in some embodiments, a user device may comprise more than one display. In some embodiments, the heads down display content 304 may be presented on one of the displays while the normal content 302 is presented on another one of the displays. In other embodiments, the heads down display content 304 or some portion thereof may be presented on each of two or more displays.

In some embodiments, the static image or video feed from the camera 108 may be presented as heads down display content 304 for a predefined period of time and then removed such that the content 302 takes up substantially all of the display 106. In other embodiments, the size of the heads down display content may be dynamically adjusted as a function of time or the detection of one or more objects or other hazards in the direction of movement of the user device. For example, on detecting a movement of a particular type, the heads down display content 304 may be automatically presented on the display 106 for a first period of time in which the heads down display content 304 takes up a first portion of the screen. After the first period of time, the heads down display content 304 may be shrunk to take up a second portion of the screen, the second portion being smaller than the first portion. The processor 104 may also be configured to process the image from the camera 108 to detect objects or other hazards in the direction of movement of the user device 100. On detecting an object or hazard, the user device 100 may increase the portion of the heads down display content 304 from the first portion to a larger portion of the screen or from the second portion back to the first portion.

FIG. 4 shows another example of the presentation on the display 106 on detection of a particular type of movement. The user device 100 may be running a text messaging or other chat application while the user is moving with the device. Accordingly, the display 106 presents text bubbles 402-1 and 402-2 representing a conversation between the user of the user device 100 and another individual. The heads down display 404 is displayed below the text bubbles 402 and above a text input box 406 and keyboard 408. Thus, a user of the user device 100 may simultaneously input text to the user device 100 while viewing the heads down display content 404 presenting an image of the direction of movement and viewing a conversation via the text bubbles 402.

It is important to note that the placement of heads down display content 304 in FIG. 3 and heads down display content 404 in FIG. 4 is for example only, and that embodiments of the invention are not limited solely to the arrangements shown in FIGS. 3 and 4. For example, the heads down display content 304 in FIG. 3 may be placed above the content 302 rather than below the content 302. Alternatively, the heads down display content 304 may be placed side by side with the content 302. In addition, many user devices such as cell phones may switch between portrait and landscape display modes. The respective placement of content 302 and heads down display content 304 may vary depending on whether the user device is in a portrait or landscape display mode. As another example, the heads down display content 404 may alternatively be placed above the text bubbles 402, or below the keyboard 408. Various other arrangements are possible.

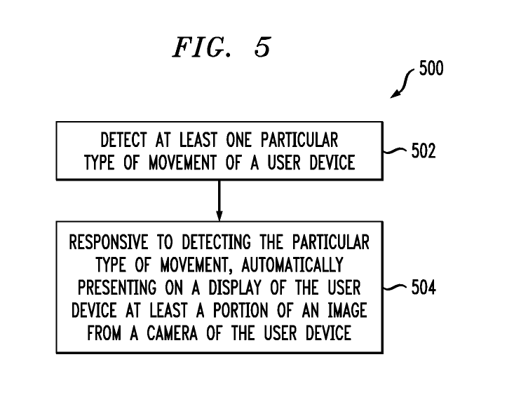

FIG. 5 shows a methodology 500 for content presentation referred to herein as a heads down display mode. The methodology 500 begins with step 502 by detecting at least one particular type of movement of a user device. Responsive to detecting the particular type of movement of the user device in step 502, the methodology 500 continues with step 504 by automatically presenting on a display of the user device at least a portion of an image from at least one camera of the user device. The user device 100 of FIG. 1 may be configured to implement a heads down display mode such as methodology 500.

User devices may be configured so as to determine a number of types of movement using position sensors. As discussed above, the position sensor 102 in user device 100 of FIG. 1 may comprise any number of or combination of sensor types. The position sensor 102 may comprise a GPS position sensor and other sensor types which can detect the speed of movement of the user device 100. The particular type of movement may be based in part on the speed of movement of the user device 100. For example, the processor 104 may receive data from the position sensor 102 which allows the processor 104 to distinguish between a user walking with the device, jogging or running with the device, or riding in a vehicle such as a car, train, etc. In some embodiments, if the speed indicates that the user is walking, jogging or running, a heads down display mode may be enabled while if the speed indicates that the user is riding in a vehicle, the heads down display mode may be disabled.

The position sensor 102 may alternatively or additionally comprise one or more sensors such as an accelerometer and gyroscope to determine an orientation of the user device 100 with respect to the ground or the direction of movement. For example, if the position sensor 102 determines that a planar surface of the display 106 is substantially parallel with that of the ground or the direction of movement of the user device 100, a user viewing the display 106 must look down at the user device 100 and is unable to determine if there are objects or other hazards in the direction of movement of the user device 100. Accordingly, some embodiments of the invention enable a heads down display mode for the user device 100 when a planar surface of the display 106 is substantially parallel with that of the ground or the direction of movement of the user device 100.

In other embodiments, the user device 100 may use a combination of sensors to track the speed of the user device 100 in addition to variations in elevation and tilt of the user device 100. Typically, as a user walks while holding a user device such as a cell phone, the device travels at a relatively slow speed and changes in elevation, tilt etc. according to the user's stride. In some embodiments, the sensor 102 or combinations of sensors may, in conjunction with the processor 104, determine that a user is actually walking, jogging or running with the device rather than simply sitting in a car or train in slow-moving traffic or various other situations. Thus, the particular type of movement which, when detected, causes the processor 104 to automatically present on the display 106 at least a portion of the image from the camera 108, may be based on the speed of the user device 100 and a variety of other factors.

Embodiments of the invention are not limited solely to enabling a heads down display mode when the user device 100 is oriented such that when the planar surface of the display 106 is substantially parallel with that of the ground with respect to the direction of movement of the user device 100. A user may be able to select a range of orientations which enable the heads down display mode for a user device 100. Alternatively, the user device 100 may be preprogrammed to enable the heads down display mode for a range of orientations of the user device 100. For example, a user may not necessarily hold the user device 100 such that the planar surface of the display 106 is parallel with the ground. Instead, a user will often hold the device at an angle with respect to the ground. In some embodiments, the orientations may be a range wherein the top surface 202 of the housing 206 of the user device 100 is elevated less than 60 degrees with respect to the direction of movement. Various other elevation ranges may be used in other embodiments of the invention as desired for a particular user device.

The camera 108 of user device 100 may be mounted such that the angle of the camera 108 may be adjusted. The user device 100 may comprise control circuitry configured to adjust the angle of the camera 108. The control circuitry may adjust the angle of the camera 108 with respect to the direction of movement of the user device 100 based on the determined orientation of the user device 100, such that the camera 108 will capture an image of the direction of movement regardless of the orientation of the user device 100.

As described above, in some embodiments, the user device 100 may have more than one camera. For example, a given user device 100 may have a camera 108 mounted on the top surface 202 of the housing as well as a rear camera mounted on a back surface of the housing opposite the display 106. On detecting a movement of the particular type, the processor 104 may be configured so as to automatically present on the display at least a portion of the image from the camera 108 on the top surface 202 of the housing, a portion of the image from the rear camera mounted on the back surface of the housing 206, or some combination of the images from two or more cameras. The respective portions of the images from the camera 108 and the rear camera may be selected based at least in part on an angle of the front surface of the housing 206 with respective to the direction of movement of the user device 100. For example, the rear camera may be positioned so as to detect objects or hazards on the ground while the camera 108 on the top surface of the housing 206 may detect other people or objects which are not viewable via the rear camera.

It is important to note that embodiments of the invention are not limited solely to single-camera user devices or two-camera user devices. Instead, embodiments of the invention may use three or more cameras, wherein in the heads down display mode at least a portion of an image from one, two or three or more cameras of the user device is presented on a display of the user device.

In some embodiments of the invention, a user device may be configured to automatically present at least a portion of an image from at least one camera on a display of the user device responsive to both: (1) detection of a particular movement; and (2) the user performing a given action on the user device. In some embodiments, the given actions may be pre-determined or pre-programmed in a memory of the user device. In other embodiments, the user may alternatively or additionally specify one or more actions or action types which trigger automatic presentation of an image from at least one camera on the display of the user device.

For example, a user device may be configured such that the heads down display mode is enabled only when the user device is on and in an active state, rather than a standby state or when the screen is idle.

As another example, the user device may be configured such that the heads down display mode is enabled only if a user is performing an input command on the device. Many user devices today now use a touch screen as the preferred or only method of input to the user device. In such devices, a user is unable to accurately type without looking directly at the screen, which presents a safety hazard if the user attempts to walk, jog or run and type at the same time. Thus, in some embodiments of the invention, the heads down display mode may be enabled whenever the user is running an application which requires the user to input text. For example, the heads down display mode may be enabled whenever a given user application such as a text messaging, word processing or other application requiring text input is being run or is active on the user device. Alternatively, the heads down display mode may be enabled only when the user is running an application which requires the user to input text and the user has selected a text input box or area of the application. As such, in some embodiments the heads down display mode may not be enabled while a user is running a text messaging application until the user attempts to enter text.

In addition, many user devices such as cell phones are equipped with a microphone which allows the user to dictate text and other input to the user device. Thus, in some embodiments of the invention the heads down display mode is not enabled when the user has activated a voice input mode.

In some embodiments, the presentation of the heads down display content 304 may be supplemented with one or more other indicators. For example, a user device may further comprise an LED status indicator, which may blink, change colors, increase or decrease in intensity, etc. to indicate that the heads down display mode is active or that heads down display content 304 is presented on the display. In addition or in alternative, a chime or other audio indicator may be used to signal that the heads down display mode is active or that heads down display content 304 is presented on the display. In other embodiments, the user device may be configured to vibrate whenever the heads down display mode is active or heads down display content 304 is presented on the display. Such indicators may additionally or alternatively indicate that one or more objects or other hazards are detected in the direction of movement of the user device while the heads down display mode is activated.

Embodiments of the invention may be implemented in the form of integrated circuits. In fabricating such integrated circuits, identical die are typically formed in a repeated pattern on a surface of a semiconductor wafer. Each die includes a memory device with a memory array, sense amplifiers and control circuitry as described herein, and may include other structures or circuits. The individual die are cut or diced from the wafer, then packaged as an integrated circuit. One skilled in the art would know how to dice wafers and package die to produce integrated circuits. Integrated circuits so manufactured are considered embodiments of this invention.

Also, the processes and methodologies, or portions thereof, described above may be implemented in the form of software that is stored in a memory of a user device and executed by a processor of the testing system. Such a memory may be viewed as an example of what is more generally referred to herein as a “computer-readable storage medium” comprising executable program code.

It should again be emphasized that the above-described embodiments of the invention are intended to be illustrative only. For example, other embodiments can use different types and arrangements of displays, input devices, etc. for implementing the described heads down display functionality. Also, the particular manner in which certain steps are performed in the signal processing may vary. Further, although embodiments of the invention have been described with respect to user devices which are cell phones, embodiments of the invention may be implemented utilizing various other user devices such as those described above. These and numerous other alternative embodiments within the scope of the following claims will be apparent to those skilled in the art.

What is claimed is:

1. A user device, comprising:
a housing having a front surface;
a processor;
a position sensor coupled to the processor, the position sensor being configured to detect at least one particular type of movement of the user device;
a camera coupled to the processor; and
a display coupled to the processor, the display being viewable through at least a portion of the front surface of the housing;
wherein the processor is configured to automatically present on the display at least a portion of an image from the at least one camera responsive to the at least one position sensor detecting a given movement of the particular type.

2. The user device of claim 1, wherein the portion of the image from the camera comprises video of a view in a direction of movement of the user device.

3. The user device of claim 1, wherein the position sensor is further configured to determine an orientation of the user device with respect to a direction of movement of the user device, the particular type of movement comprising movement of the user device at a given orientation with respect to the direction of movement.

4. The user device of claim 1, further comprising control circuitry configured to align an angle of the camera with a direction of movement of the user device.

5. The user device of claim 1, wherein the housing further comprises a back surface opposite the front surface and a top surface connecting a top edge of the front surface and a top edge of the back surface, the camera being mounted on the top surface of the housing.

6. The user device of claim 5, wherein the camera is mounted on the top surface of the housing at a given angle with respect to a plane parallel to the front surface of the housing.

7. The user device of claim 6, wherein the given angle comprises an angle such that the image from the camera substantially captures a view in a direction of movement of the user device for a given orientation of the user device.

8. The user device of claim 6, wherein the given angle comprises an angle approximately 30 to 60 degrees below a plane parallel to the top surface of the housing.

9. The user device of claim 5, wherein the camera is mounted on the top surface of the housing and a rear camera is mounted on the back surface of the housing, wherein the processor is further configured to automatically present on the display at least a portion of the image from the camera and at least a portion of an image from the rear camera responsive to the at least one position sensor detecting a given movement of the particular type.

10. The user device of claim 9, wherein the respective portions of the images from the at camera and the rear camera are determined based at least in part on an angle of the front surface of the housing with respect to a direction of movement of the user device.

11. The user device of claim 1, wherein the position sensor is further configured to detect a speed of movement of the user device, the particular type of movement comprising a particular direction of movement of the user device and a particular speed of movement of the user device.

12. The user device of claim 11, wherein the particular speed of movement is a speed indicative of a user walking, jogging or running with the user device.

13. The user device of claim 1, wherein the processor is configured to automatically present on the display at least a portion of the image from the camera responsive to a user performing a given action on the user device and the position sensor detecting a movement of the particular type.

14. The user device of claim 13, wherein the given action comprises a text input command.

15. The user device of claim 13, wherein the given action comprises running a text messaging application on the user device.

16. A cellular phone comprising the user device of claim 1.

17. A tablet computing device comprising the user device of claim 1.

18. A method comprising the steps of:
detecting at least one particular type of movement of a user device; and
responsive to detecting the at least one particular type of movement of the user device, automatically presenting on a display of the user device at least a portion of an image from at least one camera of the user device.

19. The method of claim 18, wherein the detecting step further comprises determining an orientation of the user device, the particular type of movement comprising movement of the user device at a given orientation with respect to a direction of movement of the user device.

20. A processor-readable storage medium comprising executable program code for implementing the method of claim 18.
